(19) United States
(12) Patent Application Publication
(10) Pub. No.: US 2015/0286304 A1
(43) Pub. Date: Oct. 8, 2015

(54) SOUND WAVE TOUCH PAD

(71) Applicant: HYUNDAI MOTOR COMPANY, Seoul (KR)

(72) Inventors: Hui Sung LEE, Gunpo-Si (KR); Sung Min PARK, Seoul (KR); Sung Jin SAH, Suwon-Si (KR); Kwang Myung OH, Daejeon (KR)

(21) Appl. No.: 14/480,264

(22) Filed: Sep. 8, 2014

(30) Foreign Application Priority Data
Apr. 4, 2014 (KR) 10-2014-0040444

(51) Int. Cl. G06F 3/041

(52) U.S. Cl. CPC G06F 3/041

(57) ABSTRACT

A sound wave touch pad includes a housing provided with a plurality of grooves. A pad is exposed on a surface of the housing and inserted into a groove of the housing. The pad is further configured to generate a sound wave when an external force is generated. A sound wave sensor is provided inside the housing and is configured to receive the sound wave generated from the pad

### CROSS-REFERENCE TO RELATED APPLICATION

This application is based on and claims the benefit of priority to Korean Patent Application No. 10-2014-0040444, filed on Apr. 4, 2014 in the Korean Intellectual Property Office, the disclosure of which is incorporated herein in its entirety by reference.

### TECHNICAL FIELD

The present disclosure relates to a sound wave touch pad, and more particularly, to a sound wave touch pad which helps a user to easily detect a position of the sound wave touch pad with his/her own finger and to recognize a sound wave touch only with a simple structure.

### BACKGROUND

Generally, a touch pad is linked with a computer through a screen to directly input or output information and to detect coordinates of a touched location when a human hand or an object touches a character or a specific location on a screen to carry out a specific processing corresponding to a menu selected by software from the coordinates.

Therefore, the touch pad provides an information display unit function and an input unit function.

Recently, a touch pad using a sound wave has been used. In the sound wave touch pad according to the related art, one sound wave sensor is used to recognize a position of a finger through different media. Or at least two sound wave sensors are used to estimate the position of the finger based on specific algorithm by using characteristics of sound waves that differently reaching each sound wave sensor.

However, the touch pad using the sound wave according to the related art, which is made of a hard solid material having a fixed shape, requires a driver to see or hear, thus disturbing his/her driving when the touch pad visually available or reducing his/her recognition ability for the sound when the touch pad is audibly available.

According to the related art, the touch pad is configured in a button type or a switch type, and therefore, when various functions are added, the number of buttons or switches need to be increased, and a microphone need to be mounted for position recognition. The touch pad in the related art further requires a user to inconveniently touch the touch pad with his/her hands to locate an initial position of the touch pad.

### SUMMARY

The present disclosure has been made to solve the above-mentioned problems occurring in the prior art while advantages achieved by the prior art are maintained intact.

An aspect of the present disclosure provides a sound wave touch pad, and more particularly, a sound wave touch pad which may make a user to easily detect a position of the sound wave touch pad through his/her own finger and to recognize a sound wave touch only with a simple structure.

According to an exemplary embodiment of the present disclosure, a sound wave touch pad includes a housing and a pad exposed on a surface of the housing to generate a sound wave when an external force is generated. A sound wave sensor is provided inside the housing and is configured to receive the sound wave generated from the pad.

The sound wave touch pad may further include a controller configured to be connected with the sound wave sensor to receive an electrical signal from the sound wave sensor and to recognize a position and a pattern of a user's finger, which are generated from the pad.

The pad may be provided in plural in the housing at a predetermined interval to correspond to the user's fingers.

The pads may be made of different materials.

The housing may have an inclined side, and an inclined position may be provided with the pad.

Each of the plurality of pads may be allocated to operate a plurality of function units which perform various functions.

### BRIEF DESCRIPTION OF THE DRAWINGS

The above and other objects, features and advantages of the present disclosure will be more apparent from the following detailed description taken in conjunction with the accompanying drawings.

FIGS. 1a-1c are diagrams illustrating a sound wave touch pad according to an exemplary embodiment of the present disclosure.

FIG. 2 is a diagram illustrating a state in which a sound wave is transferred to a sound wave sensor when the pad is touched in the sound wave touch pad according to an exemplary embodiment of the present disclosure.

FIGS. 3 and 4 are diagrams illustrating a state in which the sound wave touch pad according to the exemplary embodiment of the present disclosure is used inside a vehicle.

### DETAILED DESCRIPTION

Exemplary embodiments of the present disclosure will be described in detail with reference to the accompanying drawings.

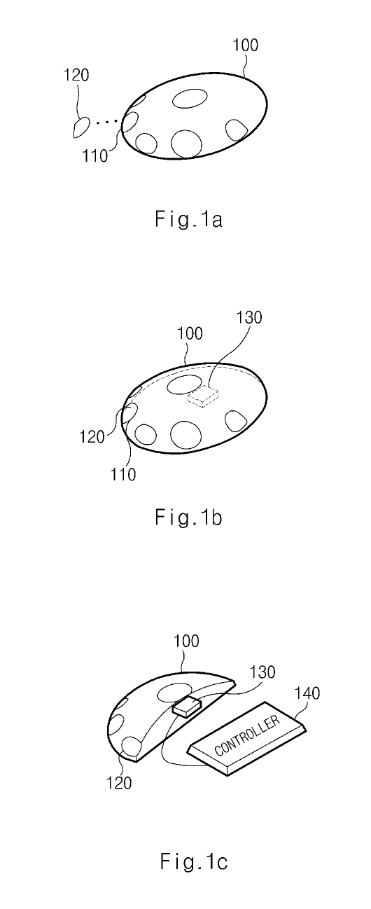

As illustrated in FIGS. 1 to 4, a sound wave touch pad according to an exemplary embodiment of the present disclosure may include a housing 100, pads 120 included in the housing 100 to generate a sound wave, and a sound wave sensor 130 receiving the sound wave.

As illustrated in FIGS. 1a-1c, the housing 100 is provided with a plurality of grooves 110, so that the pads 120 to be described below may be disposed in the grooves 110.

In this case, like a computer mouse, the housing 100 may have a shape to be easily gripped by a user's hand, however it is not limited to the embodiment herein. It may be provided with various shapes such as a cup shape and a hexahedral shape according to applications.

Further, the housing 100 may be made of a hard or soft material, but the shape thereof may be maintained.

The pads 120 are inserted or attached into the grooves 110 of the housing 100 and are exposed on an outer surface of the housing 100 to generate the sound wave when applying an external force. Further, the grooves 110 of the housing 100 may be special surface treated to generate a sound wave.

In this case, the pads 120 have a streamlined shape, and thus can be touched by a user's finger or a separate object.

The pads 120 may be made of a solid material, in which the plurality of pads may be provided in the housing 100 at a predetermined interval so as to correspond to the user's finger, and each pad 120 may be made of different materials to generate different sound waves at each finger position.

Herein, the sound wave is a sound due to a shock wave or a friction force which is generated while pressure is applied to the pads 120 by the external force such as knocking and rubbing by a user.

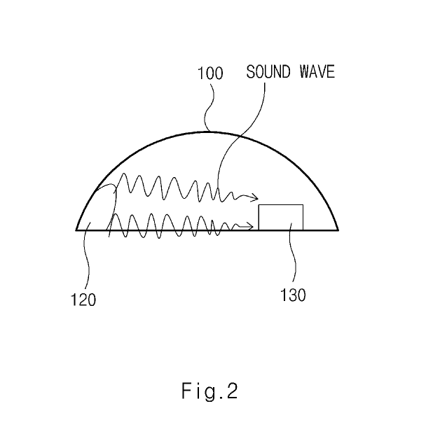

As illustrated in FIGS. 1a-1c and 2, the sound wave sensor 130 is provided inside the housing 100, which is connected with the pads 120 to receive the sound wave generated from the pads 120 and convert the received sound wave into an electrical signal.

The controller 140 is operated together with the sound wave sensor 130 to receive the electrical signal of the sound wave sensor 130 and recognizes the position and pattern of the user's finger to be transferred to the pads 120.

The housing 100 has an inclined side, and the inclined position is provided with the pads 120, such that the user may easily touch the pads 120 which are formed in the housing 100.

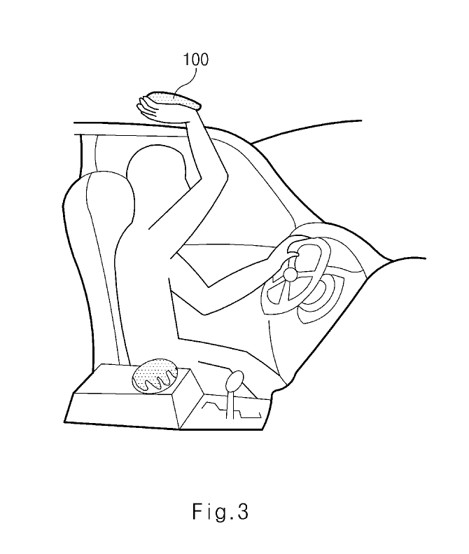

As illustrated in FIG. 3, the sound wave touch pad according to the exemplary embodiment of the present disclosure may be applied to an overhead console control system of a vehicle and may be operated by touching the pads 120 of the housing 100 instead of touching a button or a switch which is to control indoor lights and a sun roof of the vehicle.

A use example of the sound wave touch pad which is applied to the overhead console control system will be described, in which the thumb of the user is set to be No. 1, the forefinger is set to be No. 2, the middle finger is set to be No. 3, the ring finger is set to be No. 4, and the little finger is set to be No. 5.

When No. 1 finger pad 120 knocks twice on the touch pad, a driver's side light may be turned on, and when No. 1 finger pad 120 knocks again, the driver's side light may be turned off. When No. 2 finger pad 120 knocks twice, the sun roof may be slightly opened, and when No. 2 finger pad 120 knocks again, the sun roof may be opened more. When No. 3 finger pad 120 knocks twice, the sun roof may be completely opened, and when No. 3 finger pad 120 knocks again, the sun roof is completely closed. When No. 4 finger pad 120 knocks twice, the sun roof is slightly closed, and when No. 4 finger pad 120 knocks again, the sun roof is closed more. When No. 5 finger pad 120 knocks twice, a passenger's side light is turned on, and when No. 5 finger pad 120 knocks again, the passenger's side light is turned off.

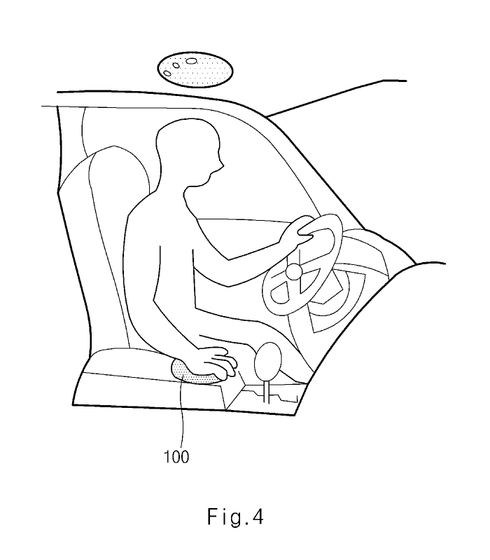

Referring to FIG. 4, the sound wave touch pad according to the exemplary embodiment of the present disclosure may also be used in an integration control system such as a driver information system (DIS) and may be operated by touching the pads 120 of the housing 100 instead of the button or the switch associated with audio, navigation, and air conditioner controls.

The use example of the sound wave touch pad 120 which is applied to the DIS integration control system will be described below.

When No. 1 finger pad 120 knocks twice, radio is turned on, and then, Nos. 2, 3, 4, and 5 finger pads 120 are changed to perform a radio function. Next, when No. 2 finger pad 120 knocks twice, the volume is increased, and when No. 2 finger pad 120 is rubbed, the volume is decreased. When No. 3 finger pad 120 knocks twice, a channel is moved up, and when No. 3 finger pad 120 is rubbed, the channel is moved down. In this case, when No. 1 finger pad 120 is rubbed, the radio is turned off, and thus returns to a basic setting. After this, No. 1 serves as the radio, No. 2 serves as the navigation, and No. 3 serves as the air conditioner, and the like.

As such, devices which perform each function, such as the indoor lights, the passenger's side light, the sun roof, the audio, the navigation, and the air conditioner, are referred to as a function unit, and each pad may be allocated to operate the function units.

According to the exemplary embodiment of the present disclosure, the housing 100 is provided with the plurality of grooves 110, and therefore, at the time of the initial touch, the finger may be easily positioned at the sound wave touch pad 120. The pads 120 provided in the grooves 110 are made of different materials, and thus, when the user knocks or rubs the pads 120, different sound waves are generated for each pad 120. In this case, the generated sound waves are converted into electrical signals by the sound wave sensor 130 and are transmitted to the controller 140, such that the position and pattern of the user's finger may be recognized.

As described above, according to the exemplary embodiments of the present disclosure, it is possible for the user to easily detect the position of the sound wave touch pad with his/her own finger so as to prevent the malfunction of the touch pad, thereby enhancing the convenience of use, and it is possible to accurately understand the user intention using the sound wave generated from the touch pad when the user's finger is operated, thereby enhancing the marketability.

Although the exemplary embodiments of the present disclosure have been disclosed for illustrative purposes, those skilled in the art will appreciate that various modifications, additions, and substitutions are possible, without departing from the scope and spirit of the disclosure as disclosed in the accompanying claims. Accordingly, such modifications, additions, and substitutions should also be understood to fall within the scope of the present disclosure.

What is claimed is:

1. A sound wave touch pad, comprising:
a housing;
a pad exposed on a surface of the housing to generate a sound wave when an external force is generated; and
a sound wave sensor provided inside the housing and configured to receive the sound wave generated from the pad.

2. The sound wave touch pad according to claim 1, further comprising:
a controller connected with the sound wave sensor and configured to receive an electrical signal from the sound wave sensor and to recognize a position and a pattern of a user's finger which are generated from the pad.

3. The sound wave touch pad according to claim 1, wherein the pad is provided in plural in the housing at a predetermined interval to correspond to user's fingers.

4. The sound wave touch pad according to claim 3, wherein the pads are made of different materials or form different surfaces.

5. The sound wave touch pad according to claim 1, wherein the housing has an inclined side on which the pad is disposed.

6. The sound wave touch pad according to claim 3, wherein each of the plurality of pads is allocated to operate a plurality of function units which perform various functions.

7. The sound wave touch pad according to claim 1, the housing is provided with a plurality of grooves.

8. The sound wave touch pad according to claim 7, the pad is inserted in each of the plurality of grooves.

9. The sound wave touch pad according to claim 1, the housing is cup shaped or hexahedral shaped.

10. The sound wave touch pad according to claim 1, the pad is a streamline shaped.
